(19) United States
(12) Patent Application Publication
(10) Pub. No.: US 2020/0109316 A1
(43) Pub. Date: Apr. 9, 2020

(54) METHOD FOR PRODUCING AN EASILY REMOVABLE FLAP AT THE ENDS OF AN ADHESIVE TAPE AND DEVICE FOR CARRYING OUT SAID PRODUCTION

(71) Applicant: Juan Bolos Jimenez, Madrid (ES)

(72) Inventor: Juan Bolos Jimenez, Madrid (ES)

(21) Appl. No.: 16/569,880

(22) Filed: Sep. 13, 2019

(30) Foreign Application Priority Data
Sep. 14, 2018 (ES) P201830890

(51) Int. Cl. C09J 7/40; B65H 37/04; B65H 18/28

(52) U.S. Cl. CPC C09J 7/405; C09J 2400/28; B65H 18/28; B65H 37/04

(57) ABSTRACT

The invention relates to a method for producing an easily removable flap at the ends of an adhesive tape, and to a device for carrying out said production, which comprises applying a piece of non-adhesive paper (3) adhered to the ends (10) of the tape (1), said paper having a width (a) less than the width (A) of the tape (1) in which it is applied and being placed at the center of the end (10) of the tape (1). The device (4) comprises, along with the reel (5) of the tape (1), a second reel (6) of a roll of paper (3), means (7) for introducing and means (12) for advancing the web of paper (3), means (13) for cutting same and means (14′) for adhering the cut piece to the web of the adhesive tape (1), and means (16) for moving and cutting the tape (1) with the piece of paper (3).

### OBJECT OF THE INVENTION

As expressed in the title of the present specification, the invention relates to a method for producing an easily removable flap at the ends of an adhesive tape and to a device for carrying out said production, providing to the function for which it is intended certain advantages and features which constitute a remarkable novelty in the current state of the art and will be described in detail below.

More specifically, the object of the invention relates, on one hand, to a method for producing an easily removable flap at the ends of an adhesive tape when it is cut for use, where said tape can be any applicable adhesive tape for sticking to any surface, such that after being placed on the desired surface, its subsequent peeling from said surface by pulling on either of its ends is extremely easy given that both ends are more visible when the tape is transparent and given that both ends are also provided with a paper flap which allows fingers to be inserted, but with said ends of the tape remaining properly fixed to the surface to which it is stuck because only the center, not the sides, of the ends is covered. Furthermore, the flap that is obtained with said method also serves at the same time for the easy removal of the initial end of the tape that is dispensed in the roll after every use. Moreover, a second aspect of the invention relates to a device specifically designed with a mechanism for carrying out the production of the flap, providing said advantages in an easy and practical manner, which can be susceptible to being adapted to any adhesive tape dispenser of those already existing on the market.

### FIELD OF APPLICATION OF THE INVENTION

The field of application of the present invention is comprised in the sector of industry and trade dedicated to the manufacture of adhesive tapes, at the same time encompassing the field of adhesive tape dispensing devices and other accessories for applying same.

### BACKGROUND OF THE INVENTION

On the market today there are many types and models of adhesive tapes for all types of uses. However, their most widespread use is for closing parcels and package which must subsequently be opened by means of peeling away the tape, and it is this operation that often represents a problem for users, on one hand because if the tape is transparent, which often occurs, it is difficult to find the ends thereof, and on the other hand, because they are often very thin materials that are hard to grip and detach by the ends of the tape to then peel it away. In industry and trade, it is often necessary to constantly open large numbers of parcels closed with seals and other packaging tapes, so it would be desirable to have a system that facilitates this task for operators and employees who have to do it, which prevents them from breaking their nails or having to use sharp tools that may cause occupational accidents.

Furthermore, another more current drawback with tapes of this type is the difficulty in finding and being able to grip and detach the initial end of the tape when it is stuck on the roll itself on which it is wound for use, whether or not a dispenser is used, since even when a dispenser is used, if said end has not been fixed to a support to prevent it from sticking to the roll, which often occurs by mistake or by oversight, it likewise sticks to the roll and is difficult to find and grip.

In fact, particularly in adhesive tapes of a certain quality, when the user tries to pull on the initial end of the tape stuck to the roll, in addition to the time invested, significant portions of tape are lost because it tears longitudinally repeated times. To avoid this, there is the well-known possibility of placing a paper or cardboard flap stuck at the initial end of the tape so that it does not stick to the roll. However, said flap must be cut previously by hand and stuck, also by hand, to the end of the tape left on the roll after every use. Furthermore, the user must remember to do this every time before releasing said end so that it does not get away and stick to the roll. Therefore, it would also be desirable to have means for preventing this drawback.

The objective of the present invention is to therefore provide a practical and effective solution to both drawbacks, by means of developing a method and a device for producing adhesive tape with a flap at its ends which, without undermining its fixability along the entire extension thereof, that is, from one end to another, once it is cut and fixed, can then be easily removed and, at the same time, is easy to hold in order to peel it away from the roll after cutting it at every use.

Moreover, and in reference to the current state of the art, it should be indicated that the applicant at least does not know of the existence of any other method or device for producing an easily removable flap at the ends of an adhesive tape, or any other invention having a similar application presenting technical, structural, and constitutive features that are equal or similar to those of the tape herein claimed.

### DESCRIPTION OF THE INVENTION

The method for producing an easily removable flap at the ends of an adhesive tape and the device for carrying out said production proposed by the invention are configured as a remarkable novelty in its field of application, since the aforementioned objectives are successfully and unquestionably attained as a result of its implementation, with the characterizing details making this possible and suitably distinguishing them being suitably included in the claims attached to the present description.

More specifically, the invention proposes, as mentioned above, a method for an adhesive tape of the type used for closing parcels or package, among other uses, to incorporate a flap at its ends that can be easily peeled away and removed, such that the subsequent operation of peeling away a portion of the tape that can be used for being stuck to a surface by pulling on it at either of its two ends so as to open the parcel or whatever it is fixing or holding, is very easy to do as a result of both ends being clearly visible when the tape is transparent, which is usually the case and makes said operation difficult, but especially as a result of said two ends being provided with respective non-adhered flaps, which allow fingers to be introduced to hold and easily pull on either any of said ends of the tape, but at the same time without said ends being properly fixed to the surface to which the tape has been stuck.

Furthermore, the flap that is obtained with said method, at the same time, also serves for the easy removal of the initial end of the tape left on the roll on which it is dispensed after every use.

To that end and more specifically, said method consists of applying a piece of non-adhesive paper that is adhered and cut along with the tape at the time of making each cut in the tape, being fixed to same such that one part of said piece of paper is adhered to the end of the portion of tape being removed as a result of said cutting and the other part of the paper is adhered to the end of the tape left on the roll, defining respective flaps for gripping the tape at both cut ends thereof.

Therefore, when the next cut is made for using the next portion of tape, the initial end thereof will already have a fixed part of paper, and at the final end where it is cut, a part of another piece of paper which, again, will have been cut at the same time as the tape so as to leave its other part at the initial end of the tape left on the roll, will be applied again, this same operation being repeated in every use.

Furthermore, it is important to point out that said piece of paper applied on the tape at the time of cutting it to divide it, leaving a part at each cut end of the tape, in any case has a width less than the width of the tape in which it is applied, such that when the cut segment of the tape is stuck on the surface for which it is intended, both ends of same are perfectly fixed and the flap is not stuck only in its central part, which allows fingers to be introduced to pull on it and facilitate the subsequent peeling away.

Similarly, at the end of the tape left on the roll, the piece of paper only covers a width of the tape, and therefore, this end is perfectly stuck to the roll but allows fingers to be introduced to facilitate its removal and use another section of tape again.

Likewise, when the tape is transparent it is very easy to identify the point where the ends of a segment of tape stuck on a surface or the end of the tape left on the roll are located since, preferably, the paper used for producing the flaps is opaque paper. Furthermore, said paper can be colored and/or include printed elements of any type.

In the preferred embodiment of the invention, the piece of paper forming the flap that is adhered to the tape in each cut is a rectangle about three centimeters in length and having a width that occupies about two thirds of the width of the tape for which it is intended.

Moreover, a second aspect of the present invention relates to a mechanical device specifically designed for carrying out said method, i.e., for making cuts in tape of any type of those existing on the market by applying the pieces of paper determining the aforesaid the flaps at the two, initial and final, cut ends every time a portion of tape is removed, but this does not mean that it cannot be done manually, which obviously makes it simpler, said device preferably having been envisaged to be designed so that it may adapt to any adhesive tape dispenser of the type already existing on the market.

For said adaptation, for example, the device comprises a casing with measurements and a shape that allow, in most cases, being housed in current adhesive tape dispensers.

In any case, the device comprises the incorporation, along with the standard roll of adhesive, of a roll of paper, for example coming from the consumables of dot matrix printers, and a set of rollers for introducing the web of paper between which it passes such that they make it advance by means of pressing on a push button provided after said rollers, the initial path of which corresponds to the movement of a gear rack moved by said push button to determine the advancement of the material and which, at the same time, determines the cutting of the web of paper with a blade incorporated at the end of said push button, which, once cut into a rectangular piece of paper, is adhered to the adhesive tape which, in turn, passes such that it is guided and pressed by a second group of upper rollers, between which an applicator roller is intercalated which, in this case, moves upon being driven manually when the user pulls on the end of said paper, this driving being performed until the point of the device where there are incorporated means for cutting the tape, for example, by means of actuating a second push button which cuts it due to the action of a second blade incorporated at the opposite end thereof.

In any case, it should be pointed out that the device for producing the flap object of the invention can vary and be simpler or automated, without detriment to the end product, that is, the production of a flap at the end of any adhesive tape that can be used for closing parcels or of the end of the roll on which it is wound.

The method described for producing an easily removable flap at the ends of an adhesive tape and the device for carrying out said production therefore represent an innovation in structural and constitutive features unknown up until now, and these reasons combined with its practical usefulness provide it with sufficient grounds to be granted the exclusive privilege that is sought.

### DESCRIPTION OF THE DRAWINGS

To complement the description that is being made and for the purpose of helping to better understand the features of the invention, a set of drawings is attached to the present specification as an integral part thereof, in which the following has been depicted in an illustrative and non-limiting manner:

FIG. 1 shows a schematic perspective view of an example of a segment of tape with easily removable flaps at its ends obtained by means of the method and device of the invention, where the shape and arrangement thereof once cut and fixed on the surface on which it is stuck can be seen.

FIG. 2 shows a schematic perspective view of an example of roll of adhesive tape with the easily removable flap at its end obtained by means of the method and device of the invention, where the shape and arrangement thereof can be seen.

FIG. 3 shows a schematic elevational view of an embodiment of the device for producing the easily removable flap at the ends of an adhesive tape, object of the invention, where the parts and elements it comprises, as well as the configuration and arrangement thereof, can be seen.

FIG. 4 shows a schematic elevational view of the rear part of a portion of tape, with the paper incorporated at the point of cutting of said paper for producing the flaps at the respective ends thereof determining said cut.

### PREFERRED EMBODIMENT OF THE INVENTION

In view of the mentioned drawings and according to the numbering used, there can be observed an example of adhesive tape with easily removable flaps at its ends obtained by means of the method object of the invention, and an example of a device for producing said flaps in the tape, which comprises the parts and elements indicated and described in detail below.

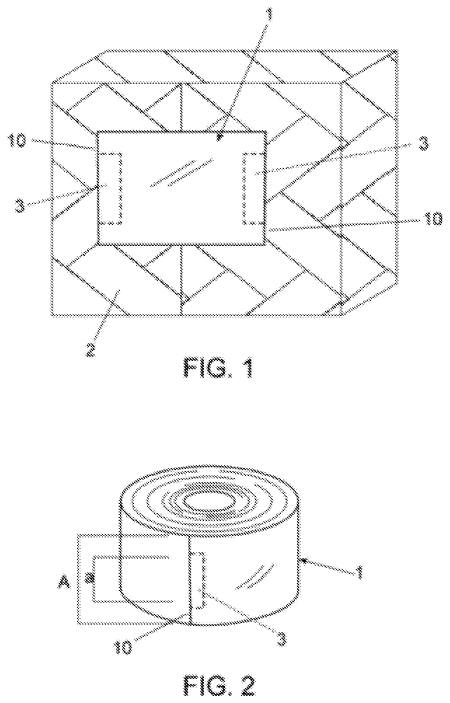

Thus, as can be observed in FIGS. 1 and 2, the method which allows the production of an easily removable flap (100) at the ends of any adhesive tape (1), both at the ends (10) of a segment of the adhesive tape used for fixing to a surface (2), as shown in FIG. 1, and at the end (10) of the tape (1) that is left to be dispensed on a roll, as shown in FIG. 2, comprises the application of a piece of non-adhesive paper (3) adhered to said ends (10) of the tape (1) and having a width (a) less than the width (A) of the tape (1) in which it is applied, such that at said ends (10) the tape (1) is stuck on both sides of the paper (3) located at the center of said end (10) acting like a flap (100) by allowing fingers to be inserted so as to pull on it.

Furthermore, said piece of non-adhesive paper (3) is preferably adhered to the ends (10) of the tape (1), being cut along with said tape (1) at the time of making each cut in the tape, being fixed to same such that one part of the piece of paper (3) is adhered to the end of the portion of tape (1) being removed as a result of said cutting and the other part of the paper (3) is adhered to the end of the tape (1) left on the roll.

Preferably, the piece of paper (3) that is adhered to the ends (10) of the tape (1) is a rectangle about three centimeters in length and its width (a) occupies about two thirds of the width (A) of the tape (1) for which it is intended.

Furthermore, the piece of paper (3) is preferably opaque, such that when the tape (1) is transparent, it is very easy to identify point at which any of the two ends (10) of a segment of tape (1) stuck on a surface (2), as shown in the example of FIG. 1, or the end (10) of the tape (1) left on the roll, as shown in FIG. 2, are located.

Finally, the method contemplates that the application of the piece of non-adhesive paper (3) adhered to the ends (10) of the tape (1) is preferably performed by using a mechanical device (4) which can optionally be adapted to dispensers already existing on the market for dispensing an adhesive tape (1).

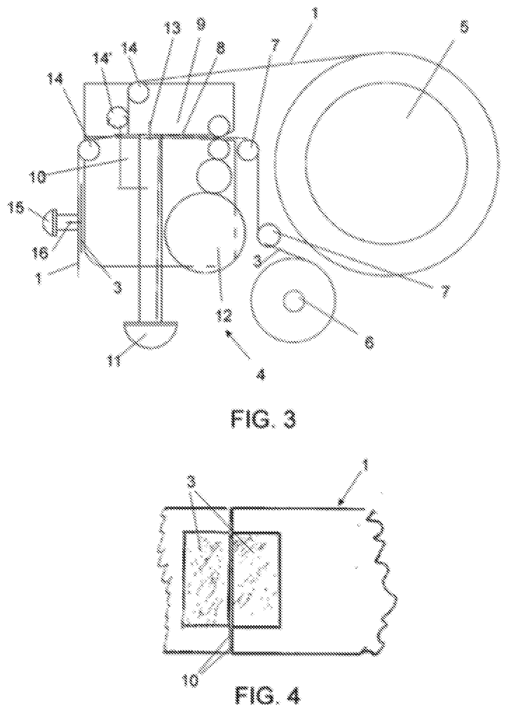

Considering FIG. 3, it can be observed how, in one embodiment option, the mentioned device (4) comprises, housed along with the reel (5) of the standard roll of adhesive tape (1), the incorporation of:
a second reel (6) of a roll of non-adhesive paper (3),
a series of lower rollers (7) for introducing the web of paper (3) between which said paper (3) passes in a guided manner such that they conduct it to a narrow space or channel (8) defined between two facing support surfaces, an upper support surface (9) and another lower support surface (10) in the example depicted according to the observer's point of view,
a first push button (11), associated in its initial path with a gear rack mechanism (12), and with a first blade (13) located at the end opposite the head of the push button (11), arranged such that each time the push button (11) is actuated, the gear rack (12) advances the web of paper (3) towards said channel (8) while at the same time the blade (13) cuts it, so that the cut rectangular piece of paper (3) can be adhered to the web of the adhesive tape (1) which, in turn, passes through said channel (8),
a second series of upper rollers (14), among which a push roller (14′) is contemplated, arranged such that they guide and press the web of the adhesive tape (1) after the channel (8) in which the roll of paper (3) advances, so that it is adhered to it once cut, and
means for moving and cutting the adhesive tape (1), in this case, manual means, being moved upon being driven manually when the user pulls on the end of said paper, and a second push button (15) with a second blade (16) at the opposite end thereof, arranged such that, upon pressing same, it cuts the tape (1) along with the piece of paper (3) since it is placed in a coinciding manner so that there is a part of paper (3) adhered at each cut end (10) of the tape (1).

It must be understood that said device (4) is only one embodiment since its configuration and elements may vary, comprising, in any case, essentially the following:
the second reel (6) of a roll of non-adhesive paper (3),
the means (7) for introducing and means (12) for advancing the web of paper (3) to a space with means (13) for cutting the paper and means (14′) for adhering the cut rectangular piece of paper (3) to the web of the adhesive tape (1), and
the means (16) for moving and cutting the adhesive tape (1), along with the piece of paper (3) placed in a coinciding manner so that there is a part of paper (3) adhered at each cut end (10) of the tape (1).

FIG. 4 shows the rear part of a portion of the tape (1), with the paper (3) incorporated on both sides of the point of cutting of said paper, which allows obtaining flaps at the respective ends (10) thereof determining said cut.

Having sufficiently described the nature of the present invention, as well as the manner of putting it into practice, it is not considered necessary to expand on this explanation so that one skilled in the art will understand its scope and the advantages derived from it, hereby stating that within its essential nature, the invention may be carried out to practice in other embodiments which differ in detail from that indicated by way of example and which will likewise attain the protection that is sought provided that its fundamental principle is not altered, changed, or modified.

1. A method for producing an easily removable flap at the ends of an adhesive tape, of any existing adhesive tape (1), both at the ends (10) of segments of adhesive tape used for fixing to a surface (2) and at the end (10) of what is left for being dispensed in a roll, characterized by comprising the application of a piece of non-adhesive paper (3) adhered to said ends (10) of the tape (1); said paper (3) having a width (a) less than the width (A) of the tape (1) in which it is applied; and said non-adhesive paper (3) being placed at the center of the end (10) of the tape (1), such that at said ends (10) the tape (1) is stuck on both sides of the non-adhesive paper (3) located at the center of said end (10), acting like a flap (100) by allowing fingers to be inserted so as to pull on it.

2. The method for producing an easily removable flap at the ends of an adhesive tape according to claim 1, characterized in that the piece of non-adhesive paper (3) is adhered to the ends (10) of the tape (1), being cut along with said tape (1) at the time of making each cut in the tape, being fixed to the same such that one part of the piece of non-adhesive paper (3) is adhered to the end (10) of the portion of tape (1) being removed as a result of said cutting and the other part of the non-adhesive paper (3) is adhered to the end (10) of the tape (1) left on the roll.

3. The method for producing an easily removable flap at the ends of an adhesive tape according to claim 1, characterized in that the piece of non-adhesive paper (3) that is adhered to the ends (10) of the tape (1) has a rectangular shape with about three centimeters in length and its width (a) occupies about two thirds of the width (A) of the tape (1) for which it is intended.

4. The method for producing an easily removable flap at the ends of an adhesive tape according to any of claim 1, characterized in that the piece of non-adhesive paper (3) that is adhered to the ends (10) of the tape (1) is opaque.

5. The method for producing an easily removable flap at the ends of an adhesive tape according to claim 1, characterized in that the application of the piece of non-adhesive paper (3) adhered to the ends (10) of the tape (1) is done by a mechanical device (4).

6. A device for producing an easily removable flap at the ends of an adhesive tape with the method described in claim 1, characterized by comprising, housed along with a reel (5) of the standard roll of adhesive tape (1), the incorporation of:
a second reel (6) of a roll of said non-adhesive paper (3),
means (7) for introducing and means (12) for advancing a web of said non-adhesive paper (3) to a space with means (13) for cutting the same and means (14′) for adhering a cut rectangular piece of said non-adhesive paper (3) to a web of the adhesive tape (1), and
means (16) for moving and cutting the adhesive tape (1), along with the piece of non-adhesive paper (3) placed in a coinciding manner so that there is a part of the non-adhesive paper (3) adhered at each cut end (10) of the tape (1).

7. The device according to claim 1, characterized by comprising, in addition to a reel (5) of the roll of tape (1):
a second reel (6) of a roll of said non-adhesive paper (3),
a series of lower rollers (7) for introducing a web of said non-adhesive paper (3) between which said non-adhesive paper (3) passes in a guided manner such that they conduct it to a narrow space or channel (8) defined between two facing support surfaces (9, 10),
a first push button (11), associated in its initial path with a gear rack mechanism (12) and with a first blade (13) located at the end opposite the head of the first push button (11), arranged such that each time the first push button (11) is actuated, the gear rack mechanism (12) advances the web of non-adhesive paper (3) towards said channel (8) while at the same time the first blade (13) cuts it, so that a cut rectangular piece of non-adhesive paper (3) is adhered to the web of the adhesive tape (1) which, in turn, passes through said channel (8),
a second series of upper rollers (14), with an applicator roller (14′), arranged such that they guide and press the web of the adhesive tape (1) after the channel (8) in which the roll of non-adhesive paper (3) advances, so that it is adhered to it once cut, and
means (16) for moving and cutting the adhesive tape (1) along with the piece of non-adhesive paper (3).

8. The device according to claim 7, characterized in that the means for moving the adhesive tape (1) along with the piece of non-adhesive paper (3) are manual driving means, where a user pulls on the end of said non-adhesive paper, and the means for cutting the tape (1) with the piece of non-adhesive paper (3) is a second push button (15) with second blade (16) at the opposite end thereof, arranged such that, upon pressing the same, it cuts the tape (1) along with the piece of non-adhesive paper (3) since it is placed in a coinciding manner so that there is a part of non-adhesive paper (3) adhered at each cut end (10) of the tape (1).
